(19) United States
(12) Patent Application Publication
(10) Pub. No.: US 2005/0138042 A1
(43) Pub. Date: Jun. 23, 2005

(54) Method and system for facilitating virtual exchange of documents in an internet commerce system

(76) Inventors: Chris Fook-Choong Foo, Costa Mesa, CA (US); Yoon Chin, Richmond Hill (CA)

Correspondence Address: Chris Foo, P.O. Box 28151, Santa Ana, CA, 92799, US

(21) Appl. No.: 10/740,314

(22) Filed: Dec. 19, 2003

(51) Int. Cl. G06F 17/00

(52) U.S. Cl. 707/100

(57) ABSTRACT

This method and system allowed businesses to implement a virtual electronic documents exchange to facilitate business transactions. This system was developed allowing trading partners to upload or exchange electronic documents without any translation or mapping software setup on the local machine. Based on the pre-configured input from the users, the electronic documents can either be distributed and accessed via internet or transmitted to target trading partners with a process identifier performing tasks simultaneously. Users are provided by a standard input and output document templates which closely parallel to the paper based documents. This method allowing businesses to implement costs effective electronic documents exchange as well as providing a mechanism to promote sales.

### SUMMARY

Methods and apparatus consistent with the present invention, as embodied and broadly described herein, provide a simple and costs effective standard form based method for businesses to exchange documents without having to invest in the data translation or mapping process. In addition, this invention also allowing information such as pickup orders to be instantaneously make available to the target trading partners where goods can be conveniently obtain by users at the physical location of their choosing. Furthermore, data files transmitted to target system can be instantaneously processed with client daemon program installed at target machine.

This invention resolved three problems:
1. With standard forms provided by hosted web Service Company, businesses subscribe to this service do not needed to have any data mapping or translation software install on their local machine. In addition to that, these businesses do not even need any complicated business application as well. All information can be easily entered via the standard business forms provided and defined by the hosted web service company.
2. While data is being transmitted to recipient trading partner, a process identifier also created to trigger the execution of process in the recipient trading partner machine. This provided an instant process of the data file received.
3. With the rules based setup, buyer can retrieve information from one centralized system rather than forwarded the link to third party sites which provides more selection that eventually lead to lost of sales. In addition to that, buyers are now has the flexibility to drop off or pickup goods at selected physical location based on the information entered to hosted database. As this information will be instantaneously transmit to the target location or store-front from hosted web Service Company.

### BACKGROUND

Traditionally, companies with EDI capabilities define the proprietary EDI layout or the application data layout before transmitting to their trading partners. This approach not only required tremendous amount of resources in setting up an infrastructure but frequently, the layout required changes. Throughout the years, there might be few versions of layout to be maintained for every transaction send to the same trading partner. Furthermore, smaller businesses are not able to conduct any businesses with those who already have EDI capable. This is a major hurdle for most small business as they often stored the information in Microsoft Excel format which is not commonly use for data exchange.

To solve the problem, some businesses created its own web site which provided links to its supplier web sites. Not only up-to-date information such as product availability or pricing might not be at the most current. Also, this approach created problems to some of the businesses such as to those distributors who want to protect its pricing or limit the options available to the buyer in order to stay compete with others.

In addition to that, those businesses with tradition EDI capable often require hours before the data files received and processed into their system.

### DETAILED DESCRIPTION

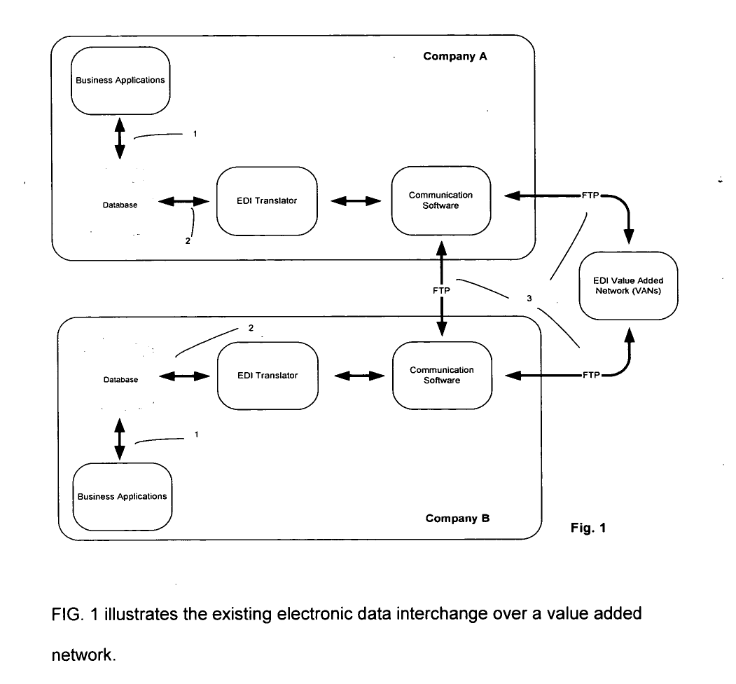

FIG. 1 illustrates the existing electronic data interchange over a value added network. 1 shows business application updating the database which at a pre-determined period trigger the generation of data for Electronic Data Interchange (EDI) mapping. The EDI translator residing on the server will scan a specific inbound directory looking for generated data files to process. 2 Based on the trading partner profile setup on the local server, the EDI translator will retrieve the EDI map and translate the data to a common EDI standard. 3 Upon complete the translation, the communication software usually a File Transfer Protocol script (FTP) will transmit the translated EDI files to an EDI Value Added Network (VANs) to be routed to recipient trading partner mailbox or mailslot. The recipient trading partner also required similar software installed on their local server such as EDI communication software, EDI translator or mapper as well as a comprehensive EDI infrastructure.

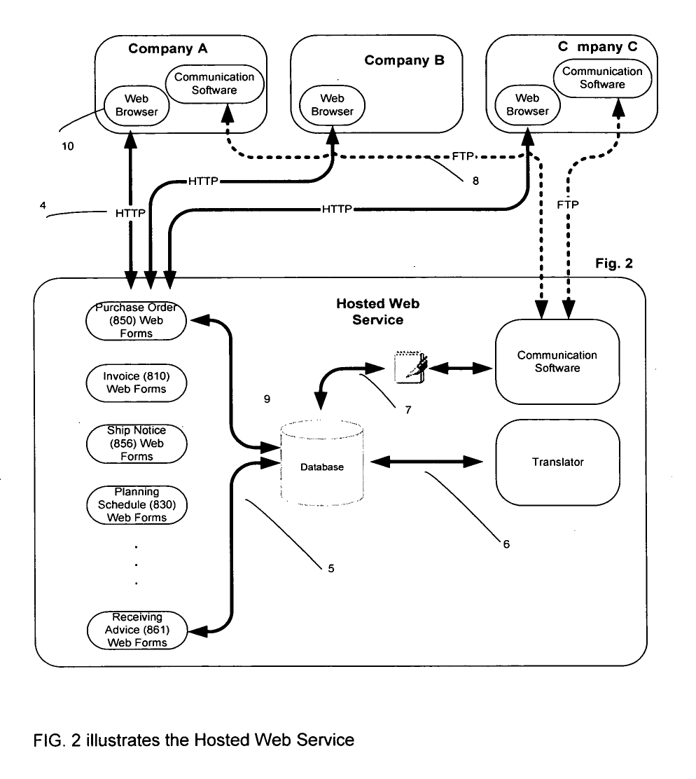

FIG. 2 demonstrate how a hosted web service provide businesses that do not have the capacity to setup translation or mapping software on the local machine to implement electronic data interchange with major corporation. 4 These businesses can now easily log on to hosted web service via Internet to configure their trading partner profile such as DUNS number, receiver or sender ID, EDI transactions and other transaction related information. The unique ideas of using hosted web service not only it provided a hosted EDI services on the hosted server but more important, it provides a standard business forms allowing businesses to enter or upload data to the hosted server. These forms include but not limited to purchase order, invoice, advance ship notice, debit and credit remittance advice and so on. 5 Upon successfully logon to the hosted web service, businesses can now enter or upload the data onto the hosted server. The upload data can be in ASCII format or saved as Microsoft Excel file. These data will eventually be processed and stored in the hosted database. 6 Based on the profile setup, some of the data will be extracted from the database to generate tradition EDI transactions. 7 The newly generated EDI files will be archived in the server as well as ready to be transmitted to appropriate trading partner or its value added network by the communication software. 8 A process identifier which defined during the profile setup will also be transmitted to the target computer in recipient trading partner site. The process identifier will be received by a client daemon program to activate any tasks associated with the information encoded in the identifier. The client daemon program is a software program provided by the hosted web service company used to interface with other programs that resided on the trading partner server. This approach allowing any transmitted data files to be processed instantly. Functional acknowledgement or any other transactions can also be transmitted back from the trading partner site back to hosted web service server using the same channel. 9 The transactions received from the trading partner will be processed or reconciled based on the rules setup in the profile. A standard report format will be created from the reconciled data ready for online viewing by the users. 10 Information display via the standard forms or in any other medium will be generated from hosted database rather than link the content to third party web sites. This feature provided is important to protect businesses subscribed to this service as it limit the option for some users to compare similar products or services offered by third party. Based on the rules setup on the hosted service, such as postal code, users can also retrieve physical location of its trading partner or print the pickup slip online where the goods will be pickup or drop off at that location. This is feasible due to the fact that all required information is stored at hosted database.

1. A computer-implemented method for facilitating virtual exchange of electronic business documents in an internet commerce system. The method comprising: pre-configure profile setup via a communication network; receiving and storing template data comprising a document through a communication network; translating the document if necessary according to the trading partner template; transmitting the output document on the communication network; transmit process identifier to target system; receiving acknowledgement or transactions from trading partner; provide data processing; posting and displaying product or service related information.

2. The method of claim 1, wherein pre-configure profile setup comprises login to hosted web service to configure trading partner information, document template, remote tasks to be processed and other account or communication related information.

3. The method of claim 2, wherein document template comprises electronic forms such as purchase order and invoice which closely parallel to the paper based documents.

4. The method of claim 3, wherein electronic forms comprise of layout that only used for viewing and layout that has editing capabilities.

5. The method of claim 1, wherein storing template data comprises of parsing the data from the template and inserting the data into database.

6. The method of claim 1, wherein receiving and storing template data including providing access to document template through the communication network to other nodes in the network.

7. The method of claim 1, wherein translating the document including providing data translation to any proprietary format on the hosted web service server.

8. The method of claim 7, wherein proprietary format further comprises Electronic Data Interchange (EDI) as well as other data interchanges standards.

9. The method of claim 1, wherein transmitting the output document on the communication network including sending the data of the template to trading partner or another node in the network.

10. The method of claim 9, wherein transmitting the output document including providing access to the viewing template online for other nodes in the network.

11. The method of claim 10, wherein access to the viewing template further comprises steps of logging to hosted web service to manipulate the output document stored in the database via a standard online template accommodate to trading partner choosing.

12. The method of claim 1, wherein process identifier further comprises one of static and binary content.

13. The method of claim 12, wherein binary content further comprises trading partner's information such as remote program name, IP address, session ID, process tasks etc.

14. The method of claim 1, wherein transmit process identifier to target system further comprises the steps of: receiving process identifier by trading partner's daemon software and execute remote program.

15. The method of claim 14, wherein daemon software is a computer program listens for incoming connections from remote computer on a specific port or Internet Protocol address and interacts with them.

16. The method of claim 14, wherein execute remote program further comprises obtaining a single instance of class Runtime that allows the daemon software to interface with the environment in which the daemon is running.

17. The method of claim 15, wherein specific port comprises one static number ranging from 1024-9999 uniquely for every computer.

18. The method of claim 1, wherein receiving acknowledgement from trading partner further comprises the steps of: parsing or translating the received data; updating received data into the database; storing and archiving received files.

19. The method of claim 1, wherein provide data processing further comprises the steps of: reconcile and compute data stored in the database; providing access to download or view the reconciled data via standard template.

20. The method of claim 19, wherein reconcile and compute data further comprises the steps of: generate report from the reconciled data; and distribute the report to trading partner for viewing.

21. The method of claim 1, wherein posting and displaying product or service related information further comprises the steps of: receiving market request via a network; associating the request with at least one of the product or service; processing the request to produce a result.

22. The method of claim 21, wherein processing the request further comprises rules or constraints for displaying collateral information related to the product or service.

23. The rules or constraints as claimed in claim 22, wherein the product or service related information will be retrieved from the hosted web service database instead of linked to trading partner web site.
